(19) United States
(12) Patent Application Publication
(10) Pub. No.: US 2024/0273583 A1
(43) Pub. Date: Aug. 15, 2024

(54) Nature-Based Shelter Apparatus with Environmental and Social Sponsorship Method

(71) Applicant: Living Canopies Ltd, University Park, MD (US)

(72) Inventor: David R. Tilley, University Park, MD (US)

(21) Appl. No.: 18/444,303

(22) Filed: Feb. 16, 2024

Related U.S. Application Data
(60) Provisional application No. 63/479,306, filed on Jan. 10, 2023.

(51) Int. Cl. G06Q 30/0279; A01G 25/00; E04H 1/12

(52) U.S. Cl. CPC G06Q 30/0279; A01G 25/00; E04H 1/1205

(57) ABSTRACT

A method and apparatus are provided sustainability and equity programs. The method connects the apparatuses with a Environmental, Social, and Governance sponsor who funds maintenance and operation for the shelter. The sponsor displays a message on the public utility and on a public website or social media platform. The apparatus consists of sensors stationed on public utilities to gather data, process it into metrics, and report to the public. The utilities include environmentally-friendly shelters at bus stops. The shelters include a green roof system and living canopies to mitigate stormwater runoff and provide shade and cooling to reduce the local temperature heat load. The shelter includes lighting, water management, solar panels, and USB charging ports, and displays for sponsor information. The metrics include air quality, temperature, humidity, sunlight exposure, the count of waiting riders, pedestrians, passing cars, stormwater collection, and solar electricity product and consumption at the location.

### CROSS-REFERENCE TO RELATED APPLICATIONS

This application claims the benefit of provisional application Ser. No. 63/479,306, filed Jan. 10, 2023, the entire contents of which is hereby incorporated for all purposes.

### FIELD OF THE INVENTION

The present invention relates generally to the integration of nature-based public infrastructure, such as bus stop shelters, with technology to offer a novel environmental apparatus and system combined with a new public-private business method that can increase the number of public amenities and access to them. More specifically, it pertains to an apparatus, method and system that combines public infrastructure, environmental sensors, data processing, and publicly sharing impactful data and personal narratives across social media, the internet and on the local infrastructure to support an Environmental, Social, and Governance (ESG) sponsorship program that boosts public amenities for adapting to the effects of climate change in urban environments. This innovative environmental apparatus and business method aims to enhance transparency, provide meaningful environmental sustainability and social equity metrics, foster a connection between corporate social responsibility and real-world impacts, and facilitate positive linkages between public entities and private sponsors. The focus on nature-based infrastructure emphasizes the environmentally conscious and sustainable aspects of the invention, aligning with societal needs and corporate objectives.

### BACKGROUND OF THE INVENTION

Challenges in Funding Public Infrastructure that provides Environmental and Social Goods and Services:

### Siting, Construction, and Maintenance of Bus Stop Shelters:

Municipal Budget Constraints: Supporting the placement, construction, and upkeep of bus stop shelters has been a persistent challenge for municipalities, often hindered by competing budget priorities (Schmitt 2018). Across the U.S., approximately only 100,000 of the 500,000 bus stops have shelters. In addition, the existing, traditional shelters 1) degrade the environment by increasing stormwater runoff and excessive heat, 2) fail to boost community resilience in light of climate change, 3) generally lack modern amenities like solar-powered lighting and green infrastructure, like green roofs and living canopies, and 4) do not inspire support from private sources of funding like foundations and corporations.

Prevalent Advertising Business Model: The dominant business model that supports bus stop shelters revolves around advertising. It is highly common for out-of-home advertising brokers to finance the installation and maintenance of bus stop shelters, sell advertising space on them, and lock municipalities into lengthy, multi-decade contracts, while sharing a portion of the revenue in return. While this advertising model has provided a large portion of the nearly 100,000 shelters across the United States over the last few decades, it is deficient in meeting the full demand of nearly 500,000 shelters needed by communities that rely on public transportation. By being able to fund only 1 in 5 shelters for bus stops, a significant shortfall exists, which exposes waiting passengers to the excessive heat and inclement weather that is exacerbated by climate change (Lanza and Durand 2021). The failure of the ad model is particularly acute in historically underserved neighborhoods, where the need is high due to them representing higher proportions of bus ridership. Nationally, 70% of bus riders are from households with incomes under $50,000, while 65% are non-white (Thompson 2020).

### Air Quality and Heat Monitoring in Urban Environments:

Data Collection Difficulties: Gathering accurate, consistent, and timely information on air quality and excessive heat in urban environments has proven to be a formidable task (Salmond and McKendry 2009). This is especially problematic in Historically Underserved Neighborhoods (HUN), where disparities in resources and infrastructure exacerbate the challenge of obtaining reliable data (Nielsen and Sidhu 2014).

The limitations, challenges, and specific difficulties detailed above reveal an existing gap in current practices and technologies. They highlight the necessity for an innovative solution capable of addressing the complexities of environmental monitoring, public infrastructure support, and integration with community needs. The present invention aims to fulfill this need, providing a novel and comprehensive approach to overcome these multifaceted challenges.

### Environmental Inadequacy and Social Inequity of Bus Stop Shelters:

Environmental Design for Bus Stop Shelters: Attempts to introduce environmental design into bus stop shelters have been limited in scope (Brovarone 2021). Examples include adding extensive green roofs (i.e., a roof covering consisting of vegetation on a layer of engineered soil that is less than four inches in depth) on shelters or using recycled materials for their structures. A holistic re-imagination of the shelter as a central hub for neighborhood amenities is lacking (Loh 2021). Vulnerable populations that live in cities, like many bus riders, tend to be at higher risk of suffering from climate change (Lee and First 2023). Bus riders must wait along busy streets that are hot with poor air quality (Mowatt 2023). Urban stormwater and heat have been the bane of cities for decades, despite stricter regulations (Leber 2023). There is a need and opportunity for a new generation of shelters to provide riders and cities with:
More safe and secure shelter in the face of impending climate change
Better management of stormwater
Means to reduce greenhouse gas emissions
Ability to decrease Summer air temperatures
Opportunity to educate citizens about sustainability and responses to climate change
Create green space and friendly wildlife habitat
And other beneficial amenities.

Alternative Business Models to Support Bus Stop Shelters: In general there has been widespread failure to overcome the deficiencies of the inequitable public-private business advertising model that supports the construction and maintenance of many bus stop shelters. Clearly, with 400,000 of the 500,000 bus stops lacking a shelter, affecting millions of people, there is a need and opportunity to reimagine how shelters are financed.

### SUMMARY OF THE INVENTION

The present invention addresses limitations faced by ESG (Environmental, Social, and Governance) focused organizations in implementing in-house programs that promote sustainability and equity, particularly when their operations are not directly linked to affected communities. To foster a more substantial and widespread impact, the invention offers a verifiable and publicly transparent ESG-sponsorship program. This program incorporates a network of sensors stationed on public utilities, such as environmentally-friendly shelters at bus stops. The sensors gather data on air quality (including VOC's, PM2.5, NOx, CO), temperature, humidity, sunlight exposure, the count of waiting riders, pedestrians, passing cars, stormwater collection, and solar electricity production and consumption at the location. This collected data is then processed into actionable and meaningful metrics on sustainability and equity, and reported to a publicly available dashboard. In return for sponsorship, the ESG sponsor has the opportunity to display a tailored message on a communication panel attached to the green shelter and receive recognition on a publicly accessible website. The website shares narratives about the positive influence of the green shelter alongside the corresponding dashboard data, enhancing public awareness and appreciation for both the shelter's benefits and the sponsor's contributions to sustainability and social equity.

In some aspects, a first embodiment described herein relates to an integrated shelter apparatus including: a rigid structure attached to a foundation, with posts, a solid roof and trellises; a layered green roof system including a drainage membrane, root barrier, soil media, and plants; living canopies rooted in the green roof system and affixed to the trellises; solar panels for electricity generation, configured to also collect rainwater; a smart rainwater harvesting system with water collection, soil moisture and temperature sensors, programmable logic controls, a cellular connection for remote communication, water storage with level sensors, a battery, and a pump, configured for irrigating the green roof and living canopies and managing water balance.

In some aspects, embodiments described herein relate to a shelter, wherein the green roof system and living canopies are configured to mitigate stormwater runoff and provide shade and cooling to reduce the local temperature and heat load.

In some aspects, embodiments described herein relate to a shelter, further including an environmental sensor network capable of monitoring air quality, temperature, humidity, precipitation, and the presence of individuals under the shelter, configured to wirelessly transmit data to a central control system.

In some aspects, embodiments described herein relate to a shelter, wherein the solar panels are connected to an energy storage system, providing power for shelter amenities including lighting, water management, sensor network, and USB charging ports.

In some aspects, embodiments described herein relate to a shelter, further including display panels, both digital and non-digital, configured to present information related to ESG (Environmental, Social, and Governance) sponsorships and community notices.

In some aspects, embodiments described herein relate to a shelter, wherein the environmental sensor network, solar panels, smart water management system, and display panels are cohesively managed via a central control system.

This application details a method for funding public infrastructure through Environmental, Social, and Governance (ESG) sponsorship. This method includes identifying and engaging potential ESG sponsors and providing public recognition of the sponsors' contributions through physical acknowledgments on the sponsored infrastructure and on publicly accessible websites. A portion of the received sponsorship funds will be used for the maintenance and operation of said infrastructure. The infrastructure will include environmentally sustainable shelters with integrated green roofs, living canopies, and solar panels.

The method could also include installing environmental sensors on the infrastructure; collecting environmental data from said sensors; and providing the collected data to the sponsors as a quantifiable measure of their sponsorship impact. Additionally, the method could include disseminating information regarding the ESG impacts of the sponsorship; using both digital and non-digital display panels located on the sponsored infrastructure; and extending the dissemination to publicly accessible websites and social media platforms.

The method could also include implementation of a digital management platform for the ESG sponsorship program that includes features such as sponsor selection, determination of sponsorship levels, and comprehensive impact reporting.

The method could also provide an ESG sponsorship model that is adaptable to a variety of public infrastructures including but not limited to parks, green infrastructure, street tree canopies, public benches, and community gardens.

The method could involve the collection, composition and distribution of narratives on the topic of how the apparatus of the first embodiment and the method described above improves the lives of individuals, where distribution may be digital or non-digitally displayed on the structure or on a publicly accessible website or social media.

In some aspects, embodiments described herein relate to a shelter, further including an attached cabinet that serves as a micro-library for storing and displaying books to be shared and traded by the public.

In some aspects, embodiments described herein relate to a shelter, further including a panel for showcasing art.

In some aspects, embodiments described herein relate to a shelter, further including an attached lockable cabinet for temporarily storing packages of purchased goods deposited by a seller and collected by a buyer

In some aspects, embodiments described herein relate to a shelter, further including a rentable kiosk whereby a private business or individual leases space to operate a market for the sale of goods.

In some aspects, embodiments described herein relate to a shelter, further including a self-serve food pantry whereby an attached cabinet is stocked with non-perishable food items that can be had by people in-need of food.

In some aspects, embodiments described herein relate to a shelter system including: a rigid structure attached to a foundation, with posts, a solid roof and trellises; a layered green roof system including a drainage membrane, root barrier, soil media, and plants; living canopies rooted in the green roof system and affixed to the trellises; solar panels for electricity generation, configured to also collect rainwater; a smart rainwater harvesting system with water collection, soil moisture and temperature sensors, programmable logic controls, a cellular connection for remote communication, water storage with level sensors, a battery, and a pump, configured for irrigating the green roof and living canopies.

In some aspects, embodiments described herein relate to a system further including a green roof system and living canopies are configured to mitigate stormwater runoff and provide shade and cooling to reduce the local temperature and heat load; an environmental sensor network capable of monitoring air quality, temperature, humidity, precipitation, and the presence of individuals under the shelter, configured to wirelessly transmit data to a central control system; solar panels connected to an energy storage system, providing power for shelter amenities including lighting, water management, sensor network, USB charging ports, and other electrical loads; display panels, both digital and non-digital, configured to present information related to ESG sponsorships and community notices; an environmental sensor network, solar panels, smart water management system, and display panels cohesively managed via a central control system.

### BRIEF DESCRIPTION OF THE DRAWINGS

FIG. 1 illustrates an apparatus including a cool green shelter, in accordance with a representative embodiment.

FIG. 2A illustrates a front elevation view of an apparatus including a cool green shelter.

FIG. 2B illustrates a side elevation view of an apparatus including a cool green shelter.

FIG. 3 illustrates a diagram of the rainwater harvesting and water management system as embodied on a cool green shelter.

FIG. 4 illustrates a flow chart of a method for providing an ESG Sponsorship business model, in accordance with a representative embodiment.

### DETAILED DESCRIPTION OF THE INVENTION

The present invention offers an innovative and multifunctional approach that tackles the complex issues surrounding environmental sustainability, public infrastructure enhancement, and the promotion of corporate social responsibility. This detailed description encompasses an environmentally sustainable and socially equitable shelter apparatus and system that serves as an amenity platform for the community, complete with a sophisticated sensor network for real-time environmental monitoring. The invention integrates nature-based technologies, advanced data processing capabilities, cloud-based services, and a user-friendly dashboard interface, all aimed at facilitating effective data dissemination and analysis. A key component of this invention is the Environmental, Social, and Governance (ESG) sponsorship model, which not only supports the financing and maintenance of these shelters but also aligns corporate participation with impactful social and environmental goals. Additionally, the invention places a strong emphasis on the strategic and equitable placement of these shelters, particularly focusing on Historically Underserved Neighborhoods, thereby ensuring broader access to public amenities and contributing to social equity and environmental justice.

### Description of a Cool Green Shelter for Bus Stops

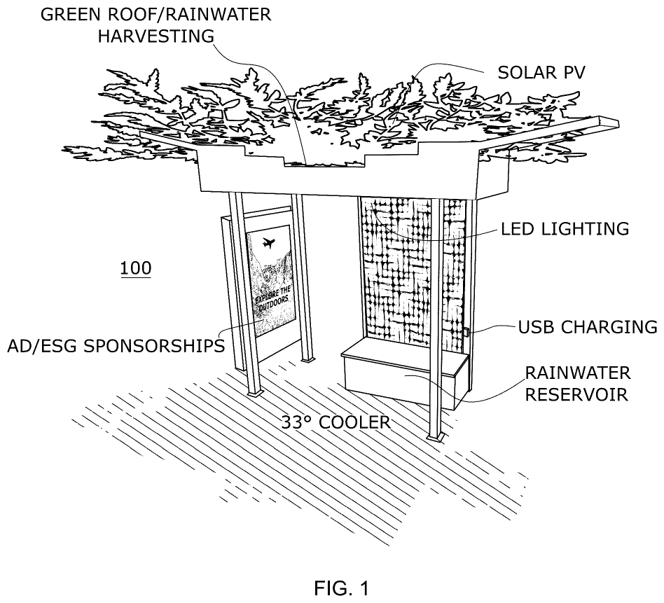

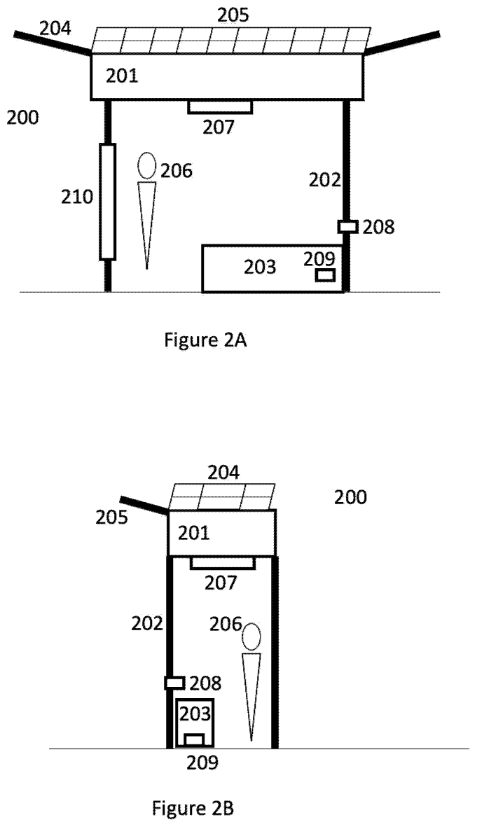

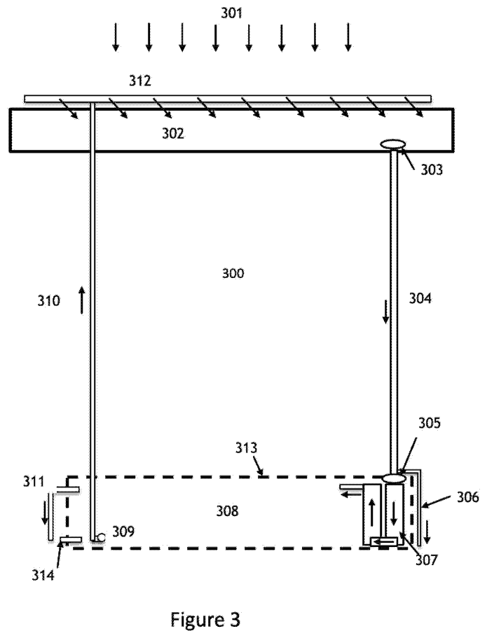

Overview: The cool green shelter of FIGS. 1, 2A and 2B is characterized by being a shelter 100/200 with green roof/rainwater harvesting, solar PV, LED lighting, USB charging, rainwater reservoir, and AD/ESG sponsorships. The shelter 200 is of such a size and height as to accommodate protecting multiple people 206 from the elements of the environment. It is unique as a shelter in that it has a green roof 201 on top of the main roof structure and living canopies 204 on trellises located to either end that extend the amount of coverage given by live plants. Additionally, there is an expanse of solar panels 205 along the back side that extends the spatial coverage and powers the electrical systems that may include lighting 207, device charging 208 and irrigation systems 300. The roofing system is integrated with a smart irrigation system that consists of pump, logic controller, plumbing system and water storage 203 to serve as a rainwater harvesting system FIG. 3. The double-sided end panel 210 affixed to the posts 202 serves as a communication device whereby it hosts messaging and visualizations to be shared with the surrounding community and passersby.

Green roofs and living canopies: The green roof 201 consists of plants, a shallow engineered soil of high porosity and low density, a root barrier, and a drainage layer. The engineered soil's low density keeps the load requirements lower than if natural soil were used. The engineered soil's high porosity promotes high permeability to water flow and good water storage characteristics. The high porosity also maintains good air flow to the roots, which promotes healthy plant growth. A variety of plants can be grown in the green roof.

The living canopies consists of a rigid trellis 204 that supports the horizontal spreading growth of vining plants. The vines are rooted in the engineered soil. The vines attach naturally to the trellis as they extend their stems and leaves. A variety of vining species can be grown on the living canopies.

Green Shelters can be designed with beneficial pollinator habitat by using the correct plant species (Matt et al. 2015). Flowering vines, like passion flower and honeysuckle, are loved by pollinators. Trumpet-like vines (e.g. Mandevilla spp. and Campsis spp.) can be used to attract hummingbirds.

Nature-based Sequestration of Carbon Dioxide: The live plants of the green roof and living canopies sequesters carbon dioxide from the atmosphere as they photosynthesize. Plant growth is a natural way to remove excess carbon from the atmosphere. The net productivity of the green roof and living canopies stores carbon from photosynthesis in woody tissues and soil organic matter over periods of decades, thus serving as a medium-term storage for carbon and net sink for greenhouse gasses.

As an example, a living plant canopy of a Green Shelter can sequester up to 7 kg-CO2 per year as part of its photosynthesis and net productivity (Tilley et al. 2014).

Nature-based Air Purification: The biofiltration of air is known to remove toxic compounds, making the quality of air safer for humans (Darlington et al., 2000, Ibrahim et al., 2018). The green roof's soil system supports an air biofiltration process to remove harmful air toxicants, especially those pollutants deemed hazardous by the US EPA (e.g., particulate matter 2.5 microns in diameter, nitrous oxides, sulfurous oxides, carbon monoxide, benzene, toluene). The air biofiltration system consists of ventilation tubes connected to air pumps that direct the shelter's ambient air into the subsurface of the engineered soil. There air pollutants are dissolved into the soil-aqueous microlayer for metabolism and uptake by soil microbes and plant rhizomes, or are adsorbed to soil particles. Thus, concentrations of air pollutants are lower in the biofilter's exhaust air. The effect of the soil biofilter is to clean the ambient air to make it safer for the waiting riders and pedestrians passing by.

Air quality is also improved by the passive uptake of hazardous air pollutants by live plants, the surface organic layer of the soil and the soil microbiome, all associated with the green roof and living canopies (Irga et al., 2023). Thus, the green roof and living canopies clean the ambient air to make it safer for the waiting riders and pedestrians passing by.

Nature-based Cooling and Shading: The invention reduces the effect of the Urban Heat Island Effect by having live plants that perform their natural process of transpiration, which provides evaporative cooling of the ambient air, and shading, which is due to the combined effects of reflection and absorption of solar radiation. Transpiration is the process whereby plants transform liquid water taken up via their roots into vapor as it is released through their stomata. Thus a phase change of water from liquid to vapor occurs, which is also referred to as a latent energy process. The ultimate effect is that the live plants can cool the temperature and shade the space surrounding the shelter using nature-based processes.

Cloyd (2017) showed that a fully vegetated living umbrella, a predecessor to the Green Shelter, provided an amount of shade equivalent to an urban street tree, which meant that it gave 10% more shade (i.e., 10% less solar transmittance) than old-fashioned fabric umbrella. He also found that the vegetated canopy made people feel 8° F. cooler than a fabric umbrella. The dark roof of a typical hard roofed bus stop shelter will easily reach 140° F. during the Summer, while a Green Shelter's vegetated roof will remain below or at ambient air temperatures, reducing the heat load on waiting riders.

Solar Electric Power: Solar panels attached to the roof produce electricity to power the shelter's electrical system, provide additional shade and supplement rainwater collection. Thus, the solar panels are used in a novel, multidimensional way so that the shelter gains additional environmental (clean power, stormwater retention) and equitable (shade, device charging) benefits.

Sunlight that strikes the solar panels is converted into electricity that is transmitted to an electrical battery, where the electrical energy is stored and made available for later use by the system of electrical loads. The solar panels are sized to generate at least 10 watts of electricity at peak solar load. The battery is sized to store at least 2 amp-hours of electricity.

By utilizing solar power to make electricity, the shelters provide off-grid electricity for charging personal devices to riders and neighborhood residents. It also powers the lighting and all the electrical loads located on the shelter without relying on greenhouse gas emitting energy sources. The off-grid system has the added benefit of making the neighborhood more resilient during power interruptions, which boost the safety and security of residents.

As an example, a Green Shelter with 300 watts of solar panels that charge a 12 v 100 Ah rechargeable battery, can power 1) 2 USB outlets for charging personal devices, 2) a smart irrigation system, and 3) a set of LED lights that produce 25 W of light, throughout a day.

Rainwater Harvesting and Stormwater Management: An advanced novelty of the invention is the smart water harvesting and management system FIG. 3 which is used to manage water storage in the cistern and supplement the live plants' demand for water beyond what is available from rainfall. The components of the rainwater harvesting and management system include: soil moisture sensors located in the engineered soil 302 are connected to the smart irrigation controller and combined with locally available weather data to control the rate and frequency of irrigation. The programmed algorithm on the controller is used to determine when water stored in the cistern should be pumped up to the engineered soil for plant uptake or wasted to the environment in preparation for an impending storm event.

Rainwater 301 that falls on the green roof and the solar panels flows down through the engineered soil 302 and to an impermeable layer that directs it to the drain 303 that feeds 304 the rainwater to a filtration system 305 before entering the water cistern 308 located beneath the seating bench 313. Storm overflow 306 discharges water in the event of flow exceeding intake capacity of filtration system 305. Water in the cistern is pumped 309 & 310 and distributed 312 to the plants rooted in the engineered soil of the green roof to meet the plants' needs for biological production and transpiration. Logic in the smart controller uses a soil moisture sensor to determine when the pump will operate. Water used by the plants supports their growth and health, and contributes to cooling the temperature of the shelter's microclimate via evaporative cooling of plant transpiration. When there is excess water in the cistern it flows out naturally 311 or can be actively pumped 314, operated by the smart controller, for example when a rain storm is impending and extra storage capacity is needed.

Therefore, the Smart Rainwater Harvesting and Management System benefits the local watershed by acting as a microstorage of stormwater, reducing the detrimental impacts of urban rainfall on local water bodies. This assists towns and cities in meeting their stormwater regulations promulgated by the US Clean Water Act. The rain harvesting and management system supports irrigation of the green roof and living canopies, which increases leaf transpiration and thus helps cool ambient temperatures, and encourages plant growth which supports uptake of toxic air pollutants and sequestration of carbon dioxide used for photosynthesis.

As an example, a 5′×10′ non-green, bus stop shelter generates 27 gallons of stormwater runoff from a 1″ storm. In contrast, the Green Shelter captures and stores this runoff, with its green roof directing rainfall to a 100-gallon cistern. Furthermore, the shelter's vine-canopy intercepts rainfall, reducing throughflow and delaying peak runoff by up to 15 minutes (Schumann 2008, Tilley et al. 2012, Schumann and Tilley 2022).

Novel Green Space for Better Mental and Emotional Health: The presence of a novel cool green shelter on a city street or nestled on a neighborhood side street can boosts the mental health and wellness, and emotional state of residents and visitors because exposure to green space reduces people's heart rates, blood pressure and stress hormones, like cortisol (Bloemsma et al., 2021). Several studies have demonstrated that students at schools with ready-access to green space perform better (Dadvand et al., 2015). Neighborhoods with improved green space have been shown to experience lower crime rates (Bogar and Beyer, 2016). Multiple experimental studies have shown the positive influence of green space and access to nature have on human physical, mental and emotional health (Frumkin et al., 2017).

Improved transit ridership starts with a holistic perspective on mobility: Encouraging and assisting people to ride public transit can be improved when every facet of their movement from origin to destination is considered. Typically a person's origin and destination will be home, work or a shopping location. Waiting for the bus or other form of transit typically requires standing along the street at the transit stop. The wait can be long or brief depending on the timeliness and frequency of the transit, and it is often mentally and physically stressful because riders are trying to get somewhere on-time and they are exposed to the elements and vagaries of the weather. Having a mentally stimulating, physically secure and emotionally calming shelter can reduce a rider's level of stress and encourage them to take public transit more often to avoid the use of personal transit. Taking the public option reduces greenhouse gas emissions because it avoids the emissions of a personal auto. Thus by encouraging more public transit ridership the Green Shelter helps to lower greenhouse gas emissions.

As an example, the carbon offset from less use of personal vehicles—assuming the shelter encourages at least 10 more riders per day per a stop—is estimated to be 2800 kg-CO2/y.

Hosting Amenities Encourages Community Engagement: As a physical node in the multiplicity of mobility options within a community, the bus stop shelter can emerge as a place for social, economic and cultural activity that adds value to the neighborhood and improves the well-being of its residents (Brovarone 2020). The Green Shelter can serve as a node for the exchange of books, information, goods and food. In one example the Green Shelter hosts a digital community board for the exchange of information. In a second example, the Green Shelter has a cabinet that can act as a small library that hosts books and other reading materials to support the free exchange of said books. Presently, it is common in many neighborhoods for there to be a “Little Free Library”. The Green Shelter can replicate this type of amenity. In a third example, the Green Shelter can serve as self-serve food pantry whereby a cabinet is stocked with non-perishable food items that can be had by people in-need of food. In a fourth example, the Green Shelter can serve as a rentable kiosk whereby a private business or individual leases space to operate a market for the sale of goods. In a fifth example, the Green Shelter displays the art of local artists for a period of time. The display can serve as an award for which the art community aspires. It can also be used as a part of an art market exchange, whereby displayed art is sold or auctioned. In a sixth example, the Green Shelter includes digitally locked cabinets whereby sellers can deposit packages of goods, securely store them for a brief period, and subsequently have them collected by a buyer with whom they have shared the digital key to unlock the cabinet.

Serving as a neighborhood node for the exchange of information, art and goods provides a valuable service that can encourage residents to place extra value on the Green Shelter that goes beyond its attributes as a shelter for bus riders. This extra value translates into better engagement that can have ancillary benefits such as less vandalism and a higher sense of community ownership of the Green Shelter.

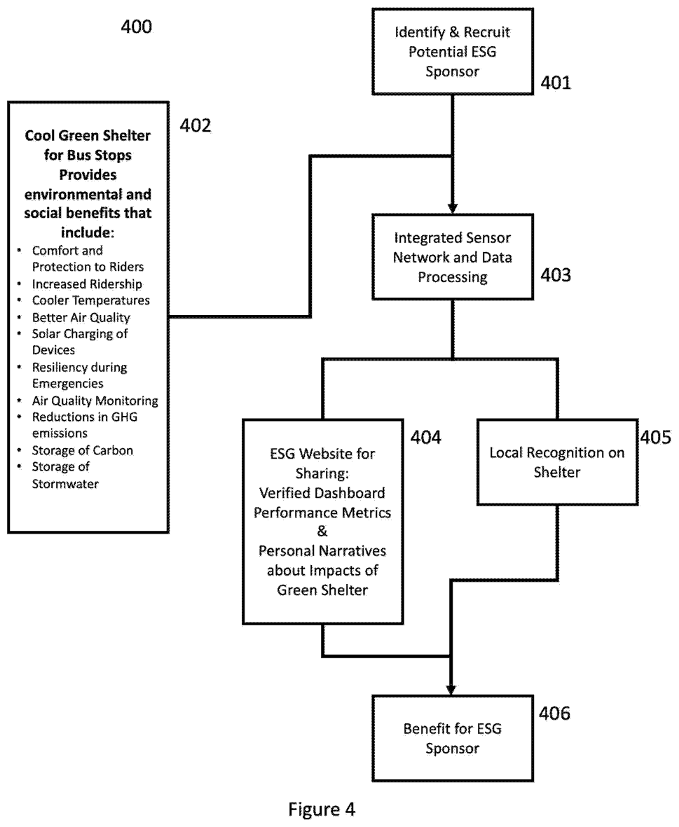

ESG Sponsorship Business Technology to improve the quality and quantity of Shelters for Transit Systems: The invention's cutting-edge ESG Sponsorship business technology 400, illustrated in FIG. 4, forms the basis for supporting a new ESG Sponsorship Business Model that will expand the number of bus shelters across the US, especially in historically underserved communities, and improve their quality as cool, comfortable and secure places to wait.

In overview the ESG Sponsorship Business Model (“ESG Sponsorship”) is an integrated physical and digital platform that allows ESG-focused entities, such as corporations and foundations, to sponsor the purchase and/or on-going maintenance of a Green Shelter in return for their participation being communicated to the public in both local and global communication channels. The ESG Sponsorship consists of a series of networked elements that seamlessly connect sponsors with a Green Shelter, collects data and narratives on the environmental and social benefits of the Green Shelter, processes the collected data and narratives into meaningful metrics and stories that are palatable to the public, and finally distributes the meaningful data and stories locally on the Green Shelters and globally across the internet and social media platforms.

### Description of the Components of the ESG Sponsorship:

### Identification and Recruitment of Potential ESG Sponsors

Identification and Recruitment of Potential ESG Sponsors: The list of potential ESG Sponsors 401 includes multinational corporations, small and medium sized businesses, especially local businesses, philanthropic foundations, and other organizations and enterprises that have robust ESG Programs and who recognize how purchasing an ESG Sponsorship will benefit their mission. The list is built from scouring the publicly available ESG reports published by these entities and identifying individuals within the entities that are appropriate points of contact, contacting local businesses and networking at professional meetings.

Recruitment 401 includes describing how the ESG Sponsorship model works and explaining the environmental, social and marketing benefits that stem from an ESG Sponsorship to persuade the points of contact and owners of the entities that participation is valuable to them, the environment and communities.

### Sensor Network

Composition and Placement: The invention utilizes a variety of sensors stationed on public utilities 403 such as environmentally-friendly shelters at bus stops 402, especially within historically underserved neighborhoods. Sensors are designed to measure air quality (including VOC's, PM2.5, NOx, CO), temperature, humidity, sunlight exposure, waiting riders, pedestrian count, passing cars, stormwater collection, and solar electricity production and consumption 402.

Timely and Consistent Data Collection: Through careful calibration and strategic placement, the sensors provide accurate, consistent, and timely information, especially focusing on the quality of air and excessive heat in urban environments, including HUN.

### Data Processing

Processing Algorithms: Advanced algorithms 403 are employed to convert raw environmental data into actionable and meaningful metrics on sustainability and equity. This includes transforming data into quantitative insights that can be understood and applied to meet the interest and ambitions of various stakeholders.

Equity Considerations: The invention ensures that the processed data 403 reflects the unique needs and considerations of HUN, thereby fostering social equity in sustainability efforts.

### Transparency Via Publicly Available Data and Narratives

Cloud-Based Reporting: All collected data is sent to a cloud-based reporting system, allowing for real-time updates, centralized data management, and seamless access by authorized users 403.

Dashboard Interface: A user-friendly dashboard interface translates the data into visually engaging and understandable formats, making it accessible to both technical and non-technical users.

Public website: The Dashboard Interface is integrated with a publicly accessible website 404 to provide direct transparency to the public about the environmental and social metrics being generated. The website also provides personal narratives generated about the riders and residents of the neighborhood.

Local Green Shelter: ESG Sponsors are recognized within the community by placing messaging and visuals on the sponsored shelter 405.

### ESG Sponsorship

Sponsorship Integration: The invention includes a mechanism for engaging ESG sponsors, allowing foundations and corporations to actively contribute and gain recognition. Sponsors can display tailored messages and information on communication panels attached to shelters and receive public acknowledgment on a publicly accessible website.

Public Recognition and Transparency: The sponsorship is designed to be transparent and verifiable, ensuring public trust and enhancing the sponsor's image in contributing to environmental sustainability and social equity so that the ESG Sponsor benefits from their goodwill towards social equity and environmental sustainability 406.

### Equitable Placement of Shelters in HUN

Strategic Shelter Placement: The invention emphasizes the strategic and equitable placement of shelters within HUN, addressing the existing shortfall and ensuring that historically underserved communities receive essential infrastructure that adds protection, comfort and resilience.

Alignment with Community Needs: Through careful analysis and community engagement, the invention ensures that the siting, construction, and maintenance of shelters align with the specific needs and priorities of HUN, moving beyond the limitations of conventional shelter advertising models.

The present invention thus offers a robust and innovative approach, providing a multifunctional solution that encompasses environmental monitoring, public infrastructure, and corporate social responsibility. By leveraging cutting-edge technology and prioritizing community engagement, it aims to reshape the landscape of urban sustainability, equity, and corporate engagement in meaningful ways.

### REFERENCES

Bloemsma, L. D., A. H. Wijga, J. O. Klompmaker, G. Hoek, N. A. H. Janssen, M. Oldenwening, G. H. Koppelman, E. Lebret, B. Brunekreef, and U. Gehring, 2021. Green space, air pollution, traffic noise and saliva cortisol in children. Environ Epidemiol. 5(2): e141 doi:10.1097/EE9.0000000000000141
Bogar, S., & Beyer, K. M. (2016). Green Space, Violence, and Crime: A Systematic Review. Trauma, Violence, & Abuse, 17(2), 160-171.
Brovarone, E. V. (2021) Design as if bus stops mattered: exploring the potential role of public transport stops in the urban environment. Urban Des Int 26, 82-96 (2021). https://doi.org/10.1057/s41289-020-00132-8
Cloyd, N (2017). Microclimatic effects and biohiphilic properties of living umbrellas. MS thesis in Environmental Science and Technology (Advisor: D. Tilley), University of Maryland, College Park 93 pp. drum.lib.umd.edu/handle/1903/20451
Dadvand, P., M. J. Nieuwenhuijsen, M. Esnaola, J. Sunyer, 2015. Green spaces and cognitive development in primary schoolchildren. PNAS 112(26): 7937-7942
Darlington, A & Chan, M & Malloch, D & Pilger, C & Dixon, Mike. (2000). The Biofiltration of Indoor Air: Implications for Air Quality. Indoor air. 10. 39-46. 10.1034/j.1600-0668.2000.010001039.x.
Frumkin, H., G. N. Bratman, S. J. Breslow, B. Cochran, P. H. Kahn Jr, J. J. Lawler, P. S. Levin, P. S. Tandon, U. Varanasi, K. L. Wolf, and S. A. Wood, 2017. Nature contact and human health: a research agenda. Environmental Health Perspectives 125(7)
Ibrahim, I. Z., W. T. Chong, S. Yusoff, 2018. The design of the botanical indoor air biofilter system for the atmospheric particle removal. MATEC Web of Conferences 192: 02035 https://doi.org/10.1051/matecconf/201819202035
Irga, P., S. Bailes, S. Matheson, F. R. Torpy, 2023. Incorporation of green infrastructure on road tunnel ventilation stacks: potential ambient air quality improvement. J. Living Architecture 10(2): 1-15 doi.org/10.46534/jliv.2023.10.02.001
Lanza, K., & Durand, C. P. (2021). Heat-Moderating Effects of Bus Stop Shelters and Tree Shade on Public Transport Ridership. International Journal of Environmental Research and Public Health, 18(2), 463. https://doi.org/10.3390/ijerph18020463
Leber, R., 2023. Bus stops and playgrounds are too damn hot: How city design falls short to address the human experience of heat. Vox from web page at www.vox.com/climate/23742227/bus-stops-playgrounds-summer-heatwaves-shade
Lee, S., & First, J. M. (2023). Investigation of the Microenvironment, Land Cover Characteristics, and Social Vulnerability of Heat-Vulnerable Bus Stops in Knoxville, Tennessee. Sustainability, 15(14), 10866.
Loh, I. (2021). Applying Design Improvement Guidelines to Bus Stops in Tucson, AZ. Retrieved from web page at repository.arizona.edu/bitstream/handle/10150/635574/loh_arizona_0137A_21984.pdf.
Matt, S. D. R. Tilley, P. Shrewsbury, 2015. Arthropod Habitat of Green Facades in the Humid Temperate Climate of Eastern North America. Journal of Living Architecture livingarchitecturemonitor.com/articles
Mowatt, C. (2023). Assessing Green Infrastructure Interventions to Reduce Personal Exposure of Ultrafine Particles for Individuals in Bus Shelters. Retrieved from web page at researchspace.auckland.ac.nz/handle/2292/55410.
Nielsen, E., Sidhu, B. (2014). Air quality at bus stop microenvironments in a Metro Vancouver urban and suburban area. BCIT Environmental Public Health Journal. doi.org/10.47339/ephj.2014.136
Salmond, J. A., & McKendry, I. G. (2009). Influences of meteorology on air pollution concentrations and processes in urban areas. In R. E. Hester & R. M. Harrison (Eds) Air quality in urban environments. Cambridge, UK: Royal Society of Chemistry
Schmitt, A. 2018. Why We Need a Bus Shelter at Every Stop. Streetsblog USA from web page at usa.streetsblog.org/2018/10/01/opinion-we-should-put-a-bus-shelter-at-every-stop-in-America.
Schumann, L., 2008. Ecologically inspired design of green roof retrofit. MS thesis in Biological Resources Engineering (Advisor: D. Tilley), University of Maryland, College Park 277 pp. drum.lib.umd.edu/handle/1903/7399
Schumann, L. M., D. R. Tilley, 2022. Experimental evidence for delayed stormwater runoff from building roofs covered with suspended vine canopies. J. Living Architecture 9(1): 1-19.
Thompson, R., 2020. What's it really like to ride the bus while Black? Greater Greater Washington. From web page at ggwash.org/view/78825/riding-while-black.
Tilley, D., Matt, S., Schumann, L., Kangas, P., 2014. Vegetation characteristics of green facades, green cloaks and naturally colonized walls of wooden barns located in the Mid-Atlantic Region of North America. Journal of Living Architecture. 1(3): 1-35.
Tilley, D. R., J. Price, S. Matt, B. Marrow, 2012. Vegetated Walls: Thermal and Growth Properties of Structured Green Facades. Final Report to Green Roofs for Healthy Cities, Toronto.

What is claimed is:

1. A smart green shelter for sheltering from sun and precipitation comprising:
a structure configured to be affixed to the ground, said structure having a plurality of posts, a roof system supported by the posts and a trellis attached to one or more of the posts;
said roof system disposed to provide sun and precipitation shelter for a person thereunder and having:
a skyward-facing drainage surface configured to hold a root barrier, a soil medium and plants planted therein,
a roof drain to drain water from the drainage surface,
a soil medium moisture sensor disposed to detect a moisture level of the soil medium,
an irrigation manifold disposed to irrigate plants planted in the soil medium, and
a solar panel disposed to collect solar energy and to shed rainwater for draining via the roof drain;
a water management system having:
a filter, disposed to be fed water from the roof drain,
a cistern disposed to be filled by water from an outflow of the filter,
a water level sensor disposed to determine a level of water in the cistern,
an overflow outlet disposed on the cistern at an overflow level to enable overflow water to flow out of the cistern;
a pump having an inlet in fluid communication with a bottom of the cistern, an outlet of said pump in fluid communication with the irrigation manifold, and
a valve-operable drain at the bottom of the cistern,
a battery electrically connected to and chargeable by the solar panel;
a mobile device charging port electrically connected to the battery for charging a shelter user's mobile device;
a temperature sensor configured to sense an ambient temperature of the shelter; and
a control and communication system electrically connected to and configured to be powered by the battery, said control and communication system operably connected and configured to:
start and stop the pump based on a function of moisture level detected by the moisture sensor;
open and close the valve-operable drain as a function of a storm forecast; and
transmit shelter data to an external shelter data consumer, said shelter data including the ambient temperature and energy collected by the solar panel.

2. The shelter of claim 1, further comprising the root barrier and the soil medium disposed on the skyward-facing drainage surface having plants planted in the soil medium, at least one of which is vining in the trellis.

3. The shelter of claim 1, further comprising an air quality sensor, a humidity sensor, a precipitation sensor and an occupancy sensor operably connected to the control and communication system and the shelter data further includes a measure of air quality from the air quality sensor, a measure of humidity from the humidity sensor, a measure of precipitation from the precipitation sensor and a measure of occupancy from the occupancy sensor.

4. The shelter of claim 3 wherein the air quality sensor is configured to provide measures of VOC, PM2.5, NOx, and CO.

5. The shelter of claim 1, further comprising a cabinet.

6. The shelter of claim 5, wherein the cabinet comprises a book exchange such as a Little Free Library.

7. The shelter of claim 5, where the cabinet comprises a food pantry.

8. The shelter of claim 5, wherein the cabinet is a locked parcel exchange space configured to be opened by parties possessing a shared digital key.

9. The shelter of claim 1, further comprising LED lighting powered by the battery and controlled by the control and communication system.

10. The shelter of claim 1, further comprising a pedestrian sensor and a passing vehicle sensor operably connected to the control and communication system and the shelter data further includes a count of pedestrians based on the pedestrian sensor and a count of passing vehicles based on the passing vehicle sensor.

11. The shelter of claim 1, wherein the cistern is disposed below a bench sheltered by the shelter.

12. The shelter of claim 1 comprising a digital display panel and a non-digital display panel.

13. The shelter of claim 2 comprising a digital display panel and a non-digital display panel.

14. The shelter of claim 13 wherein the display panels present information related to a sponsorship of the shelter.

15. The shelter of claim 14 further comprising an air quality sensor, a humidity sensor, a precipitation sensor and an occupancy sensor operably connected to the control and communication system;
wherein the shelter data further includes a measure of air quality from the air quality sensor, a measure of humidity from the humidity sensor, a measure of precipitation from the precipitation sensor and a measure of occupancy from the occupancy sensor; and
wherein the sponsorship is an ESG (Environmental, Social, and Governance) sponsorship.

16. A system for promotion of green shelters comprising:
a shelter in accordance with claim 3;
a webserver configured as an external shelter data consumer, the webserver further configured to serve dashboard pages comprising at least some of the shelter data.

17. A method for funding public infrastructure through ESG sponsorship comprising the steps of:
providing a shelter in accordance with claim 8;
identifying and engaging an ESG sponsor;
receiving sponsorship funds;
allocating a portion of the received sponsorship funds for maintenance and operation of the shelter; and
providing notice of the sponsor's contributions on publicly accessible websites;
wherein the information related to a sponsorship of the shelter provides public notice of the sponsor's contributions.

18. The method of claim 17,
wherein the ESG sponsor is an external shelter data consumer; and
wherein information related to a sponsorship of the shelter includes shelter and sponsorship impact narratives and metrics based on the shelter data.
